(19) United States
(12) Patent Application Publication
(10) Pub. No.: US 2002/0042708 A1
(43) Pub. Date: Apr. 11, 2002

(54) Method and apparatus for outputting a datastream processed by a processing device

(76) Inventors: Hartmut Beintken, San Diego, CA (US); Bernhard Gerstenberg, Munchen (DE); Manfred Oberwestberg, Munchen (DE); Andrea Schreck, Munchen (DE)

Correspondence Address: James M. Smith, Esq., HAMILTON, BROOK, SMITH & REYNOLDS, P.C., Two Militia Drive, Lexington, MA, 02421-4799, US

(21) Appl. No.: 09/894,988

(22) Filed: Jun. 28, 2001

(30) Foreign Application Priority Data
Jul. 24, 2000 (DE) DE 100 35 965.5

(51) Int. Cl. G10L 19/00; G10L 21/00

(52) U.S. Cl. 704/201; 704/500

(57) ABSTRACT

To synchronize a decoder at the receiving end, particularly an MPEG audio decoder, with the corresponding coder operating at the transmitting end, it is proposed to supply the data decoded by the decoder to a FIFO memory, the output clock rate at which the data are read out or output from the FIFO memory, being adjusted as a function of the loading level of the FIFO memory.

### RELATED APPLICATION

This Application is a continuation of German Application No. DE 100 35 965.5, which was filed on Jul. 24, 2000.

The entire teachings of the above application is incorporated herein by reference.

### BACKGROUND OF THE INVENTION

The present invention relates to a device for outputting a datastream processed by a processing device, particularly an audio decoder.

The MPEG (Moving Pictures Experts Group) Standard is increasingly being used for transmitting digital video and audio data. This is a standard for coding and compressing digital video and audio data.

MPEG decoders, which are used in digital television receivers in connection with digital television transmission, need to be synchronized to the MPEG coder operating at the transmitting end. This synchronization is necessary in order to ensure a continuous output of the decoded video pictures and of the associated audio signal in time. Furthermore, the synchronization also has an influence on the size of the input and output buffers used in the transmitter and receiver, respectively. According to the MPEG Standard, a virtual buffer model is used as a basis for the coder, the relevant assumption being that the buffer is written to with data at once and the data are read out of the buffer at once. This virtual buffer model which, however, does not correspond to reality, is also influenced by the synchronization.

Various approaches are known for solving the problem of synchronization between the MPEG coder of the transmitter and the MPEG decoder of the receiver. Thus, synchronization information is transmitted towards the MPEG datastream, which information is used in most cases for synchronizing the clock of the MPEG decoder in the receiver with the clock of the MPEG coder or of the transmitter, respectively. For this purpose, at least one correspondingly designed phase locked loop (PLL) is needed in the receiver which, as a rule, is closed via an external voltage-controlled oscillator (VCO) which causes correspondingly high system costs. Since the MPEG datastream comprises both a video datastream and an audio datastream, even two separate phase locked loops are frequently needed, one being associated with the video datastream and the other one with the audio datastream.

A further possibility is using a free-running, i.e. non-synchronized clock in the receiver. In this case, a deviation between the clock rate of the MPEG coder at the transmitting end and the clock rate of the MPEG decoder at the receiving end would lead to an overflow or underflow of the output buffers in the corresponding video and audio output units. Thus, the clock rates of the MPEG decoder must be coupled to the clock rate of the MPEG coder by other means. In this respect, various approaches are known for the video datastream. In order to compensate for the loading levels of the output buffers, for example, individual picture areas or complete frames can be omitted or repeated. It is also possible to insert or omit individual picture lines or, respectively, the corresponding video data.

### SUMMARY

These mechanisms cannot be applied to the audio datastream since any omission or addition of audio data would lead to an impairment of the signal/noise ratio and thus to an audible crackling. Although such disturbances can be minimized with very elaborate algorithms, they can never be completely eliminated.

The present invention is, therefore, based on outputting a datastream, particularly a video datastream, processed by a processing device, particularly an MPEG decoder, where the problems described above are eliminated and reliable synchronization of the output clock from the basis of the data output, with respect to the clock of the transmitter of the datastream can be ensured with little expenditure.

According to an embodiment of the present invention, a free-running clock is used as an output clock. A memory device, particularly a memory stack device in the form of a FIFO (First-In-First-Out) memory is integrated in the output path of the datastream processed by a particular processing device, particularly an MPEG decoder. The loading level of this memory device is used for adjusting the output clock in dependence thereon. Thus, the output clock can be toggled between two different values, for example, one output clock value being lower than the minimum clock rate of the datastream and the other output clock value being higher than the maximum clock rate of the datastream.

To minimize any jitter at the switching time, a continuous adaptation of the output clock rate (frequency sweep) can also be used instead of a hard switch-over between these two output clock values.

The present invention can be used in particular in an MPEG decoder for decoding an MPEG datastream, particularly an MPEG audio datastream. In this arrangement, the invention utilizes the advantages of a free-running clock system, namely dispensing with a clock control in its proper sense, but using a stable clock, fewer analogue parts, simpler testability and better reproducibility without creating the aforementioned disadvantages in the audio path, namely the occurrence of audible crackling or the use of elaborate algorithms for eliminating such disturbances. The output clock is not generated with the aid of an elaborate phase locked loop circuit but can be generated, for example, by a simple two-position controller which is controlled, for example, by the loading level of a FIFO memory.

Naturally, however, the present invention is not restricted to this preferred application but can be applied generally to any type of data, for example also to video data which can also be output by another processing device than a decoder.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram showing a device according to a first illustrative embodiment of the present invention, and

FIG. 2 is a schematic diagram showing a device according to a second illustrative embodiment of the present invention.

### DETAILED DESCRIPTION OF THE INVENTION

The present invention will now be explained by means of an MPEG decoder application, in conjunction with the decoding of an MPEG audio datastream. The MPEG video path and MPEG video datastream, respectively, can be controlled, for example, as previously described with reference to the prior art for the free-running case.

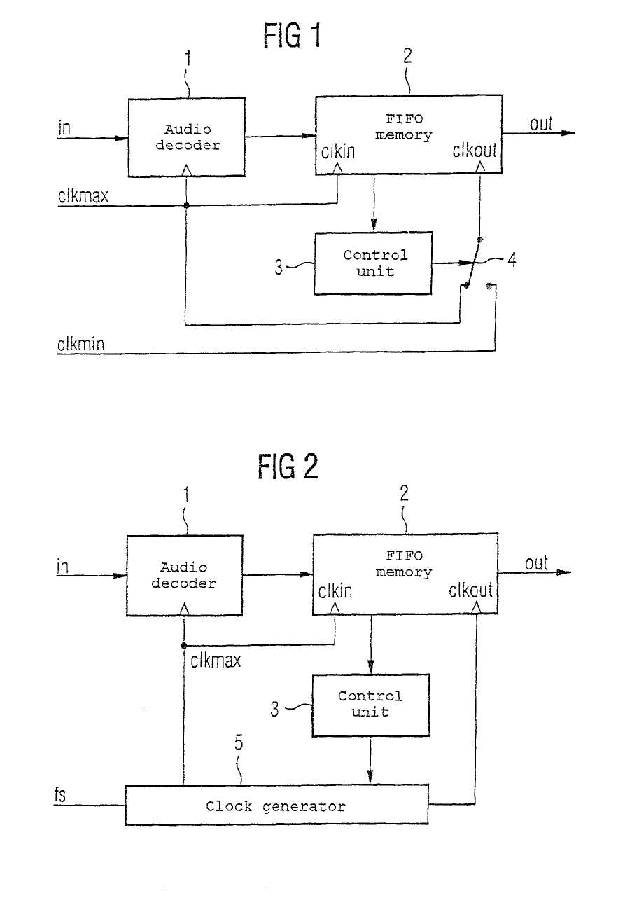

FIG. 1 shows an audio decoder 1 of an MPEG decoder which receives an MPEG audio datastream “in,” which has been coded by an MPEG coder and transmitted by a corresponding transmitter. As a consequence, the audio decoder 1 generates decoded audio data which is supplied to a buffer 2 which is constructed in the form of a FIFO memory stack in the illustrative embodiment shown. The data written into the FIFO memory 2 by the audio decoder 1 are output as output data “out” by the FIFO memory 2 in the order in which they were written, i.e., the data first written into the FIFO memory 2 are also the first data to be output.

The audio decoder 1 is operated at a clock rate clkmax which is greater than the maximum clock rate of the corresponding MPEG coder. Similarly, the decoded audio data are written to the FIFO memory 2 by the audio decoder 1 at a clock rate clkin=clkmax.

In contrast, the decoded audio data are read out or output from the FIFO memory 2 at a variable clock rate clkout. For this purpose, a control unit 3 is provided which continuously monitors the loading level of the FIFO memory 2 by evaluating the FIFO pointer, and switches the output clock rate clkout between the clock rate clkmax and a second clock rate clkmin by appropriately driving a controllable switch 4. The clock rate clkmin is selected in such a manner that it is lower than the minimum coding clock rate of the corresponding MPEG coder.

If the control unit 3 finds that the loading level of the FIFO memory 2 is below a particular limit value, the controllable switch 4 is driven in such a manner that the lower clock rate clkin which, as described, is lower than the minimum transmitter tolerance, is used as output clock clkout. If, in contrast, the loading level of the FIFO memory 2 is higher than this limit value, the control unit 3 controls the switch 4 in such a manner that the rate clkmax, which is greater than the maximum transmitter tolerance, is used as output clock clkout.

To minimize any jitter occurring at the switch-over time in the illustrative embodiment shown in FIG. 1, a continuous transition in the sense of a frequency sweep can also be provided instead of a hard switch-over between the clock rates clkmin and clkmax. A corresponding illustrative embodiment is shown in FIG. 2.

As can be seen from FIG. 2, the clock clkmax, which is greater than the maximum coding clock rate of the corresponding MPEG coder, is again used as operating clock of the audio decoder 1 and as input clock clkin of the FIFO memory 2. This clock clkmax is derived from a predetermined system clock by a clock generating unit 5. In the illustrative embodiment shown in FIG. 2, a control unit 3 continuously determines the loading level of the FIFO memory 2 by monitoring the FIFO pointer and, in dependence thereon, triggers the clock generating unit 5 in order to adjust the output clock clkout of the FIFO memory 2 correspondingly as a function of the loading level of the FIFO memory 2. In this arrangement, the output clock clkout can fluctuate between the clock clkmin, which is lower than the minimum coding clock, and the clock clkmax, which is greater than the maximum coding clock. In particular, the output clock clkout is continuously increased with increasing loading level of the FIFO memory 2.

Since the tolerances of the transmitter, and thus the deviation between the clock rates clkmin and clkmax are very small and, for example, are within a range of 30 ppm (parts per million), the required change in the output clock rate clkout is also very small. The influence of the change of the output clock rate on the sound reproduction is therefore negligible. In addition, the loading level of the FIFO memory 2 can also be used, for example, for deciding whether a corresponding correction of the output buffer, as has been described initially with reference to the prior art for the free-running case, must also be performed in the video path, or not.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for outputting a datastream processed by a processing device, the datastream processed by the processing device being output at a certain output clock rate, comprising:
supplying the datastream processed by the processing device to a memory device;
monitoring the loading level of the memory device; and
adjusting, as a function of the loading level of the memory device, the output clock rate at which the data of the datastream are output from the memory device.

2. The method of claim 1, further comprising:
writing the data of the datastream processed by the processing device into the memory device at a write clock rate which is greater than the maximum rate of the datastream supplied to the processing device.

3. The method of claim 1, further comprising:
varying the output clock rate between a first output clock rate and a second output clock rate as a function of the loading level of the memory device, the first output clock rate being lower than the minimum clock rate of the datastream supplied to the processing device, and the second output clock rate being higher than the maximum clock rate of the datastream supplied to the processing device.

4. The method of claim 3, wherein the first output clock rate is used as output clock rate if the loading level of the memory device is lower than a predetermined limit value, whereas the second output clock rate is used as output clock rate if the loading level of the memory device is higher than the limit value.

5. The method of claim 3, wherein the output clock rate is continuously adapted as a function of the loading level of the memory device, the output clock rate being increased with increasing loading level of the memory device.

6. The method of claim 1, wherein a memory stack is used as memory device.

7. An apparatus for outputting a datastream processed by a processing device, the data of the datastream being supplied to the processing device at a certain input clock rate and must be output at a certain output clock rate, comprising:
a memory device which is supplied with the datastream processed by the processing device; and
a control device for monitoring the loading level of the memory device in order to adjust, as a function of the loading level of the memory device, the output clock rate, at which the data of the datastream are to be output out of the memory device.

8. The apparatus of claim 7, wherein the data of the datastream processed by the processing device are supplied to the memory device at a certain write clock rate which is higher than the maximum input clock rate of the data stream supplied to the processing device.

9. The apparatus of claim 7, wherein the control device changes the output clock rate of the memory device between a first output clock rate and a second output clock rate as a function of the loading level of the memory device, the first output clock rate being lower than the minimum input clock rate of the datastream supplied to the processing device, whereas the second output clock rate is higher than the maximum input clock rate of the datastream supplied to the processing device.

10. The apparatus of claim 9, further comprising:
a switching device driven by the control device, the control device driving the switching device as a function of the loading level of the memory device in such a manner that the memory device is supplied with the first output clock rate as output clock rate via the switching device if the loading level of the memory device is lower than a predetermined limit value, whereas the memory device is supplied with the second output clock rate as output clock rate if the loading level of the memory device is higher than the limit value.

11. The apparatus of claim 9, further comprising:
a clock generating device which, responsive to the control device, adjusts the output clock rate of the memory device.

12. The apparatus of claim 11, wherein the control device drives the clock generating device in such a manner that the output clock rate, generated by the clock generating device for the memory device, is increased with increased loading level of the memory device.

13. The apparatus of claim 7, wherein the memory device is a memory stack.

14. The apparatus of claim 1, wherein the memory device is a FIFO memory.

15. The apparatus of claim 7, wherein the processing device is a decoding device.

16. The apparatus of claim 15, wherein the processing device is an MPEG audio decoding device for decoding an MPEG audio datastream.
